(19) United States
(12) Patent Application Publication
(10) Pub. No.: US 2013/0060992 A1
(43) Pub. Date: Mar. 7, 2013

(54) DATA COMPRESSION METHOD

(71) Applicants: KYOUNG-LAE CHO, YONGIN-SI (KR); JUN-JIN KONG, YONGIN-SI (KR)

(72) Inventors: KYOUNG-LAE CHO, YONGIN-SI (KR); JUN-JIN KONG, YONGIN-SI (KR)

(73) Assignee: SAMSUNG ELECTRONICS CO., LTD., SUWON-SI (KR)

(21) Appl. No.: 13/598,871

(22) Filed: Aug. 30, 2012

(30) Foreign Application Priority Data
Sep. 7, 2011 (KR) 10-2011-0090734

(51) Int. Cl. G06F 12/02

(52) U.S. Cl. 711/103; 711/171; 711/E12.008; 711/E12.002

(57) ABSTRACT

A data compression method includes; generating compressed data from raw data having a normal size, defining a super page for a memory having a super size greater than the normal size, selecting a compressed data set from among the compressed data having a compression ratio less than a reference compression ratio ranging between 0.5 and 1.0, and storing the compressed data set in the memory using the super page.

### CROSS-REFERENCE TO RELATED APPLICATIONS

This application claims the benefit of Korean Patent Application No. 10-2011-0090734 filed on Sep. 7, 2011, the subject matter of which is hereby incorporated by reference.

### BACKGROUND OF THE INVENTION

The inventive concept relates to a data compression methods, and more particularly, to data compression methods that may be used to efficiently store data in a page of a flash memory.

Flash memory is a particular type of non-volatile memory that may be electrically programmed and/or erased. Each memory cell in a flash memory array may be programmed or read according to a defined set of threshold voltage distributions, each threshold voltage distribution being assigned a corresponding data value. Flash memory cells may be used to store N-bit data, where N is a positive integer .

Available memory space is a limited resource in non-volatile memory systems (i.e., a memory system including at least one non-volatile memory device, such as a flash memory device, adapted to receive and store, and retrieve and provide data). Accordingly, a number of techniques have been applied to maximize the availability useful memory space within a memory system at any given point in time. In this regard, different data compression techniques have been applied to input data (or “raw” data) prior to its storage in flash memory. Data compression may be performed at different “rates” ranging from 0 to 100% (a data characteristic commonly expressed in decimal form as ranging from between 0.0 to 1.0). The use of a higher or lower data compression rate is one factor that must be considered in the design and operation of certain contemporary flash memory systems.

### SUMMARY OF THE INVENTION

In various embodiments, the inventive concept provides data compression methods that improve data compression efficiency for data stored in a flash memory system.

According to an aspect of the inventive concept, there is provided a data compression method, comprising; generating compressed data from raw data, wherein the compressed data is generated with a normal size, defining a super page for a memory, wherein the super page has a super size that is greater than the normal size, selecting a compressed data set from among the compressed data having a compression ratio less than a reference compression ratio, and storing the compressed data set in the memory using the super page, wherein the compression ratio is a ratio defined in relation to the normal size and ranges between 0.5 and 1.0.

According to an aspect of the inventive concept, there is provided a data compression method, comprising; generating a plurality of units of compressed data by compressing raw data, defining a super page having a data allocation size that is at least two times a size of the raw data, and storing at least three units of compressed data in the super page, wherein the at least three units of compressed data each has a compression ratio defined by a predetermined ratio of a size of compressed data with respect to a size of raw data, and the compression ratio is less than a reference compression ratio that ranges from between 0.5 and 1.0.

According to an aspect of the inventive concept, there is provided a data compression method, comprising a data compression method for use in a flash memory system, the method comprising; generating 1st through Kth units of compressed data from corresponding 1st through Kth units of raw data, wherein each unit of raw of data has a normal size, defining a super page for the flash memory system having a data allocation size that is at least two times the normal size and storing a number of units of the compressed data, and sequentially on a unit by unit basis for each unit of the 1st through Kth units of compressed data, determining whether the unit of compressed data has a compression ratio less than a reference compression ratio ranging between 0.5 and 1.0, if the unit of compressed data has a compression ratio less than the reference compression ratio, classifying the unit as first type, and if the unit of compressed data has a compression ratio not less than the reference compression ratio, classifying the unit as second type, and if the unit is classified as first type, storing the compressed data of the unit in the super page, and if the unit is classified as second type, storing the raw data corresponding to the compressed data of the unit in the super page.

### BRIEF DESCRIPTION OF THE DRAWINGS

Certain embodiments of the inventive concept will be more clearly understood from the following detailed description taken in conjunction with the accompanying drawings in which:

FIG. 1 is a flowchart summarizing a data compression method according to embodiments of the inventive concept;

FIGS. 2, 3 and 4 are conceptual diagrams that illustrate a data compression approach that does not use a super page;

FIGS. 5, 6 and 7 are conceptual diagrams that illustrate another data compression approach that does not use a super page;

FIGS. 8 and 9 are conceptual diagrams that illustrate a data compression approach that uses a super page;

FIGS. 10 and 11 are conceptual diagrams that illustrate another data compression approach that uses a super page;

FIG. 12 is a flowchart summarizing a data compression method according to embodiments of the inventive concept;

FIGS. 13 and 14 are graphs illustrating certain statistical data related to different compression ratios;

FIGS. 15 and 16 are respectively a block diagram and a plan view illustrating a storage device according to embodiments of the inventive concept;

FIGS. 17 and 18 are plan views illustrating the storage device of FIGS. 15 and 16 including a control unit and a storage unit according to embodiments of the inventive concept;

FIGS. 19 and 20 are plan views illustrating the storage device of FIGS. 15 and 16 including a control unit and a storage unit according to other embodiments of the inventive concept; and

FIG. 21 is a block diagram illustrating a computing system including a storage device according to an embodiment of the inventive concept.

### DETAILED DESCRIPTION

The inventive concept will now be described in some additional detail with reference to the attached drawings. The inventive concept may, however, be embodied in many different forms and should not be construed as being limited to only the illustrated embodiments. Rather, the illustrated embodiments are provided so that this disclosure will be thorough and complete, and will fully convey the concept of the inventive concept to one of ordinary skill in the art. Throughout the written description and drawings, like reference numbers and labels are used to denote like or similar features and/or elements.

The terminology used herein is for the purpose of describing particular embodiments and is not intended to limit the inventive concept. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” refers to one of or a combination of at least two listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Embodiments of the inventive concept are described herein with reference to schematic illustrations of idealized embodiments (and intermediate structures) of the inventive concept. As such, variations from the shapes of the illustrations as a result, for example, of manufacturing techniques and/or tolerances, are to be expected. Thus, the embodiments of the inventive concept should not be construed as limited to the particular shapes of regions illustrated herein, but are to include deviations in shapes that result, for example, from manufacturing.

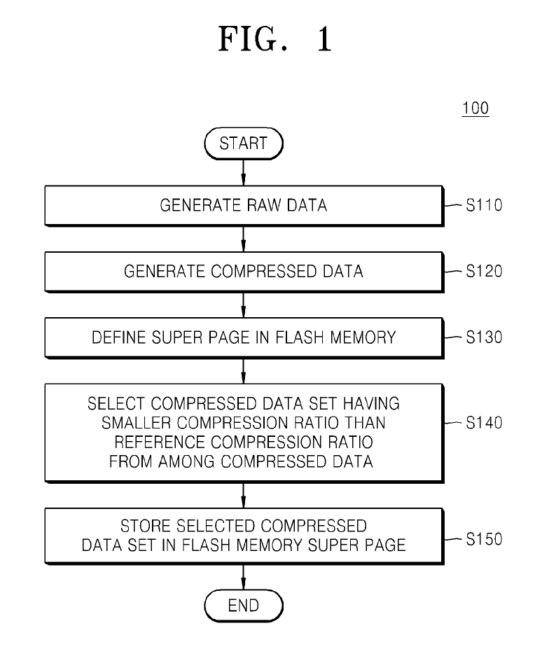

FIG. (FIG. 1 is a flowchart summarizing a data compression method according to embodiments of the inventive concept.

Referring to FIG. 1, a data compression method 100 generally comprises generating raw data (S110), generating compressed data from the raw data (S120), defining a super page in flash memory (S130), selecting a particular set of compressed data from the compressed data in relation to a defined reference compression ratio (“the selected compressed data set”) (S140), and then storing the selected compressed data set in the super page (S150).

In this context, the raw data may be directly received from or generated in accordance with input data received from a host or interface (S110). For example, when the data compression method is performed in a solid state drive (SSD), input data received via an interface may be converted into corresponding raw data using a flash transition layer (FTL). The use of a FTL in conjunction with a flash memory system is well understood in the art.

Once the raw data has been received or generated, it is compressed (S120). As is well understood by those skilled in the art, one or more data compression techniques may be used to generate the compressed data. A general “data volume” (or data quantity) relationship will exist between the raw data and compressed data, as defined by the level of data compression. This relationship is commonly expressed as a ratio ranging from 0.0 to 1.0 (i.e., the size of the raw data/the size of the compressed data).

Before, coincident with, or after data compression (S120), a “super page” will be defined by a controller (or logic unit) associated with the flash memory (S130). Generally speaking, the super page will be larger in data allocation size (i.e., capable of storing a greater quantity of data) than a “normal page” of the flash memory. Assuming raw data having a “normal size” is generated (S110), the super page will be defined (S130) to have a “super size” larger than the normal size. The super size may be a multiple of the normal size in certain embodiments. For example, if a defined super size is three times (3×) the normal size, three “units” (e.g., a bit, byte, or multiple bytes) of raw data may be stored in the super page, while four units of compressed data may be stored in the super page (assuming a compression ratio of 0.75).

Next, the body of compressed data may be scanned to identify and select at least one “set” of compressed data having a smaller compression ratio than a defined reference compression ratio. Once selected (S140), the “compressed data set” may be stored in the super page. In certain embodiments of the inventive concept, the “reference compression ratio” will be ration greater than 0.5 but less than 1.0. For example, if the reference compression ratio is 0.66, certain compressed data among the body of compressed data (“the compressed data set”) having a compression ratio that is less than or equal to 0.66 may be selected and stored in the super page. Extending this example, if the allocation super size of the super page is two times (2×) that of the normal size, three units of compressed data may be stored in the super page.

Here, as will be appreciated by those skilled in the art, the super page is a logical construct referring to a page in which data greater in size than a normal page (e.g., a plurality of normal pages) may be merged. Thus, the super page should be distinguished from a physical page storage unit that is conventionally associated with data being stored in the memory cells of a flash memory array. Accordingly, the expression “storing data in a super page” should be functionally understood as “mapping the data to the super page”. This is a logical concept, whereas the data is actually stored in flash memory according to a “physical page” defined for the flash memory.

When storing compressed data using a super page, a plurality of units of compressed data may be stored in the super page. However, if a super page is not used, a compression ratio for the compressed data stored in the page will range between 0.0 and 0.5. Hence, if the compression ratio for compressed data exceeds 0.5, only a single unit of compressed data may be stored in the page. Accordingly, there is no need to store compressed data in the page, and it is more efficient in terms of data processing speed to store the data without compression.

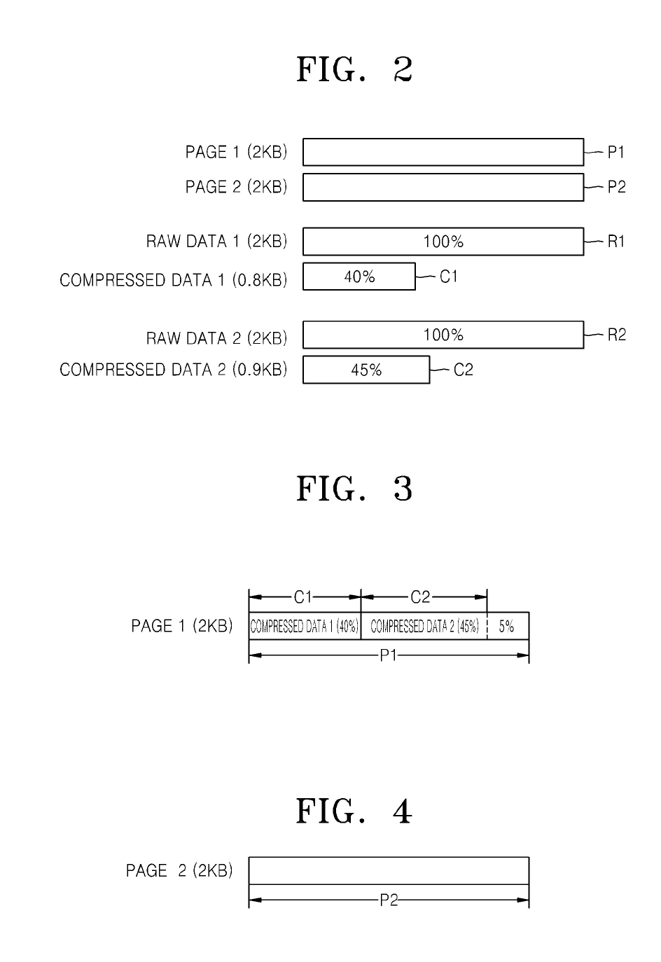

FIGS. 2, 3 and 4 illustrate data being compressed using a data compression method that does not use a super page. A reference compression ratio of 0.5 is assumed. FIG. 3 illustrates data stored in a first page P1 and FIG. 4 illustrates data stored in a second page P2, where both of pages P1 and P2 are assumed to be 2 Kbytes in size. In the illustrated embodiment, the “reference compression ratio” corresponds to the compression ratio with which compressed data was stored on a page by page basis. That is, if the assumed reference compression ratio is 0.5, this means that only compressed data having a compression ratio of 0.5 or less will be selected from among a plurality of units of compressed data and stored in a page.

Referring to FIGS. 2, 3 and 4, raw data or compressed data may be stored in the first page P1 and the second page P2. If first raw data R1 and second raw data R2 have a first size (e.g., 2 KB), then corresponding first compressed data C1 and second compressed data C2 will have a size less than the first size (e.g., 0.8 KB and 0.9 KB, respectively). In this assumed example case, the resulting compression ratios for the first and second compressed data C1 and C2 are 40% (0.40) and 45% (0.45), respectively.

Since the respective compression ratios for the first and second compression data C1 and C2 are less than the 50% (0.5) reference compression ratio, the first compressed data C1 and the second compressed data C2 are commonly be stored in the first page P1 as illustrated in FIG. 3. Accordingly, other raw data or other compressed data may be stored in the second page P2.

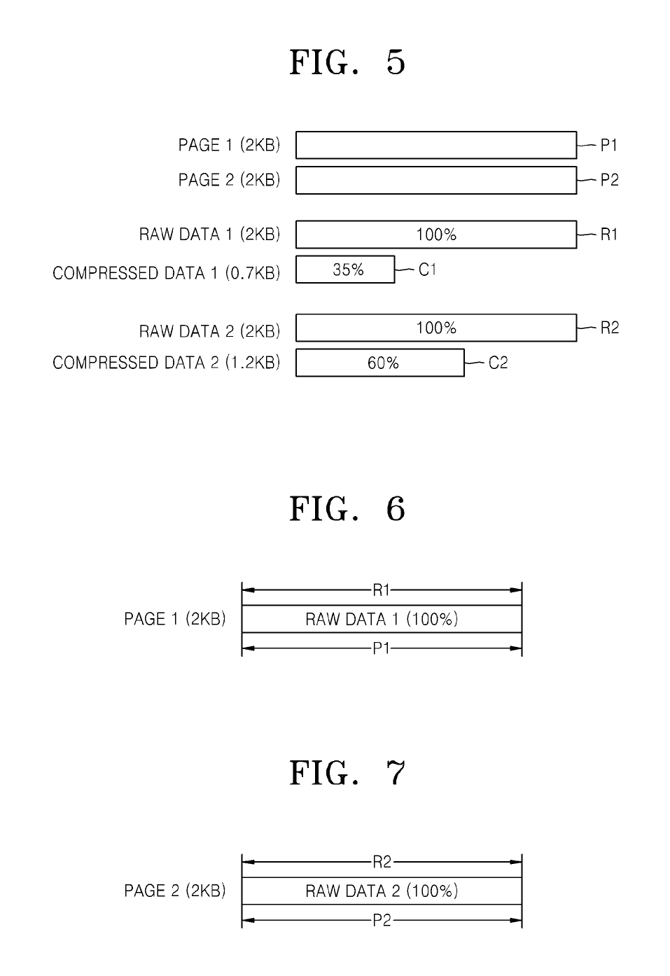

FIGS. 5, 6 and 7 illustrate data being compressed using another data compression method that does not use a super page, again assuming a reference compression ratio is 0.5. FIG. 6 illustrates data stored in a first page, and FIG. 7 illustrates data stored in a second page. Referring to FIGS. 5 through 7, as a result of compressing first and second raw data R1 and R2, first and second compressed data C1 and C2 may have sizes of 0.7 KB and 1.2 KB, respectively. In this case, compression ratios of the first and second compressed data C1 and C2 are 35% and 60%, respectively. While the compression ratio of the first compressed data C1 is equal to or less than 50%, that is, equal to or less than 0.5, the reference compression ratio, the compression ratio of the second compressed data C2 exceeds 50%. The first compressed data C1 and the second compressed data C2 cannot be stored in the first page P1, and as a result, the first raw data R1 is stored in the first page P1, and the second raw data R2 is stored in the second page P2.

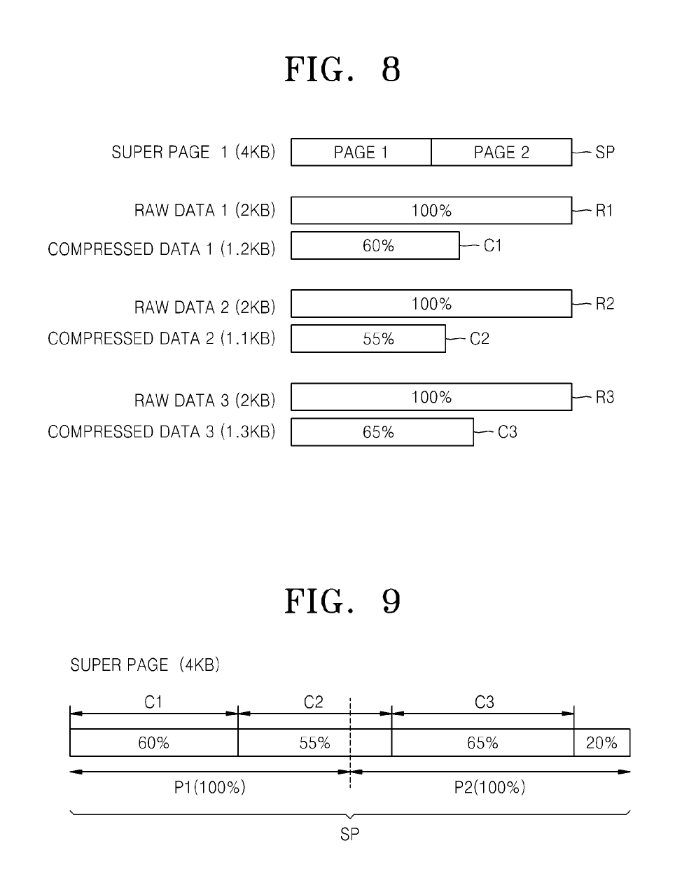

With this backdrop, a data compression method according to an embodiment of the inventive concept and using a defined super page may be understood to markedly improve flash memory efficiency. FIGS. 8 and 9 illustrate data compressed using a data compression method making use of a super page and assuming a reference compression ratio of 0.66 according to an embodiment of the inventive concept. Those skilled in the art will understand that the 0.66 reference compression ratio is merely one selected example. For example a reference compression ratio may be selected for certain embodiments of the inventive concept that range between 0.63 and 0.69.

Referring to FIGS. 8 and 9, an data allocation super size for a defined super page SP may be even-numbered multiple of a normal page size (i.e., a first size for generated raw data). FIG. 9 illustrates data stored in the super page. For example, the data allocation size of the super page SP may be two times (2×) that of the normal size, and in this case, the super page SP of FIGS. 8 and 9 may merge the first page P1 and second page P2 of the previous example. Hence, the super page SP may have a data allocation size of 4 KB, and raw data or compressed data may be stored in the super page SP.

As a result of compressing first through third raw data R1, R2, and R3, the first through third compressed data C1, C2, and C3 may have sizes of 1.2 KB, 1 KB, and 1.3 KB, respectively. In this case, compression ratios of the first through third compressed data C1, C2, and C3 are 60%, 55%, and 65%, respectively. As the compression ratios of the first through third compressed data C1, C2, and C3 are all equal to or less than 0.66, the first through third compressed data C1, C2, and C3 may be stored in the super page SP.

As described above, the super page SP is a logical concept indicating a page in which a plurality of pages are merged, and is distinguished from a storage unit of data stored in memory cells in a memory chip, that is, a page according to a physical concept. Referring to FIG. 9, the first through third compressed data C1, C2, and C3 stored in the super page SP may be divided into the first page P1 and the second page P2 and stored in a memory cell.

While pages used in flash memories and a data compression method using a super page, which is a superordinate concept of the pages are suggested according to the embodiments of the inventive concept, the embodiments of the inventive concept are not limited thereto. Data compression methods according to embodiment(s) of the inventive concept are not limited to flash memories, but may be applied to other storage media such as hard disks. A physical page (i.e., a physical unit of storage for flash memories) may correspond to a physical sector for one or more hard disks. Thus, the data compression method according to the inventive concept may be used by defining a superordinate concept of a given sector.

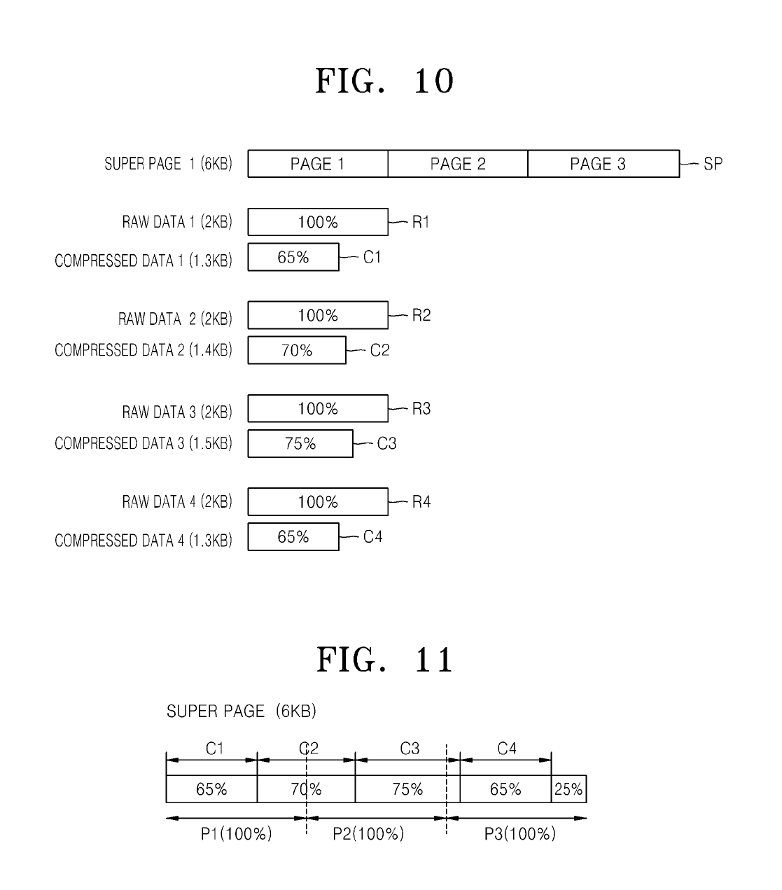

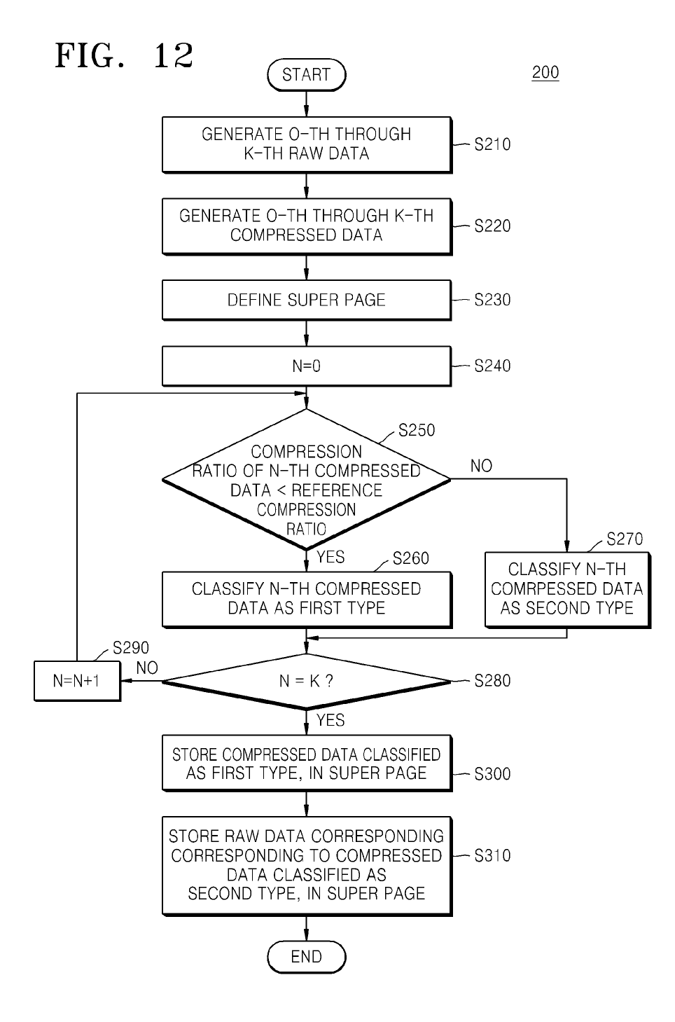

FIGS. 10 and 11 illustrate data compression using a data compression method in which a super page is used and assuming a reference compression ratio of 0.75 according to another embodiment of the inventive concept. FIG. 11 illustrates data stored in the super page. While the reference compression ratio is 0.75, the reference compression ratio may have any value between 0.72 and 0.78.

Referring to FIGS. 10 and 11, an allocation size of a super page SP may be odd-numbered multiples of a page size, that is, a first size of raw data. For example, an allocation size of the super page SP may be three times the page size, and in this case, a super page SP in which first through third pages P1, P2, and P3 are merged may be defined. The super page SP may have an allocation size of 6 KB, and raw data or compressed data may be stored in the super page SP.

As a result of compressing first through fourth raw data R1, R2, R3, and R4, first through fourth compressed data C1, C2, C3, and C4 may have sizes of 1.3 KB, 1.4 KB, 1.5 KB, and 1.3 KB, respectively. In this case, compression ratios of the first through fourth compressed data C1, C2, C3, and C4 are 65%, 70%, 75%, and 65%, respectively. The compression ratios of the first through fourth compressed data C1, C2, C3, and C4 are all equal to or less than 0.75, and thus the first through fourth compressed data C1, C2, C3, and C4 may be stored within the super page SP. Referring to FIG. 11, the first through fourth compressed data C1, C2, C3, and C4 stored in the super page SP may be divided into the first page P1, the second page P2, and the third page P3 and stored in a memory cell.

FIG. 12 is a flowchart summarizing a data compression method according to embodiments of the inventive concept. A data compression method 200 according to the embodiments of the inventive concept may be under stood as one more particular modification of the data compression method 100 previously described in relation to FIG. 1. Here, the description will focus on differences from the previous embodiments.

Referring to FIG. 12, the data compression method 200 comprises generating raw data (S210), generating compressed data (S220), defining a super page SP (S230), dividing compressed data (S250, S260, and S270), storing the compressed data in the super page SP (S300), and storing raw data in the super page SP (S310).

In more particular detail, a number of units (0-th through K-th) of raw data are generated based on corresponding input data provided by a host or via an interface. Thereafter, the 0-th to K-th compressed data corresponding to 0-th to K-th raw data may be generated.

After a super page SP is defined (S230), whether a compression ratio of N-th compressed data is less than a reference compression ratio is determined (S250). In the beginning, N=0, and thus first, it is determined whether a compression ratio of 0-th compressed data is less than the reference compression ratio.

If the compression ratio of the N-th compressed data is less than the reference compression ratio, the N-th compressed data is classified as a first type in operation S260. On the other hand, if the compression ratio of the N-th compressed data is equal to or greater than the reference compression ratio, the N-th compressed data may be classified as a second type (S270). The classifying operation may be understood as a kind of marking operation for checking whether data stored in a super page later is compressed data or raw data.

Thereafter, (S280), whether N is K is determined to determine whether the classifying operation for the whole compressed data has been conducted. If the classifying operation regarding the whole compressed data has not been performed, N is increased (S290), and operations S250, S260, and S270 are repeated.

If the classifying operation regarding the whole compressed data is performed, the compressed data classified as the first type is stored in the super page SP (S300). Meanwhile, the compressed data classified as the second type is not stored in the super page SP but raw data corresponding to the compressed data is stored in the super page SP (S310).

In this manner, compressed data having a smaller compression ratio than the reference compression ratio among K+1 units of compressed data may be stored in the super page SP. Meanwhile, the reference compression ratio may exceed 0.5 and be less than 1. Accordingly, this embodiment contrasts with an example where the reference compression ratio has to be 0 to 0.5 if a super page SP is not used.

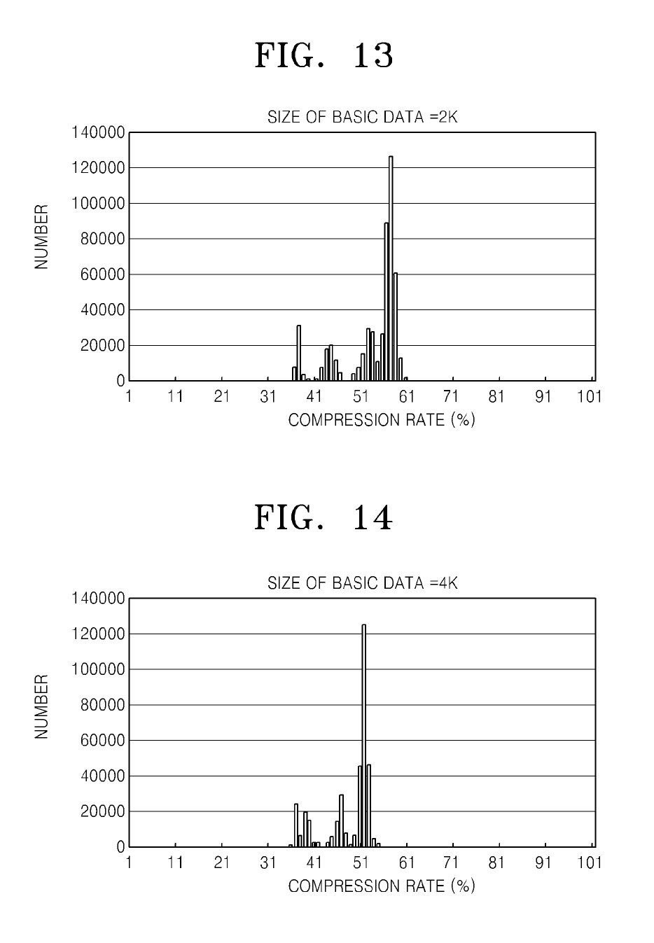

It should be noted that when the reference compression ratio exceeds 0.5 and a super page is used, a ratio of successful compression may increase, and as a result, the total compression efficiency may be improved. Certain memory system efficiency improvements may be understood from statistical data derived using data compression ratios illustrated in FIGS. 13 and 14.

As shown in FIG. 13, when compressing a plurality of units of raw data having a size of 2 KB, compression ratios of a large number of units of compressed data are between 50% and 60%. Also, as shown in FIG. 14, when compressing a plurality of units of raw data having a size of 4 KB, compression ratios of a large number of units of compressed data are between 43% and 53%. This result is obtained through software, and if a compressor is implemented by hardware, a decrease of about 10% in performance may be anticipated. Accordingly, a compression ratio of compressed data from raw data of 2 KB is mostly between 60% and 70%, and a compression ratio of compressed data from raw data of 4 KB is mostly between 60% and 70%.

If a super page is not used, the reference compression ratio must not exceed 0.5, and in this case, statistically, not compressed data but raw data may be mostly stored in a page. However, according to embodiments of the inventive concept, a super page is used, and moreover, data may be compressed based on a reference compression ratio exceeding 0.5 and being less than 1 so that a large number of units of compressed data may be stored in the super page. As a result, even when data having a high compression ratio is stored, the number of units of compressed data may be increased, and thus the total compression ratio may be improved.

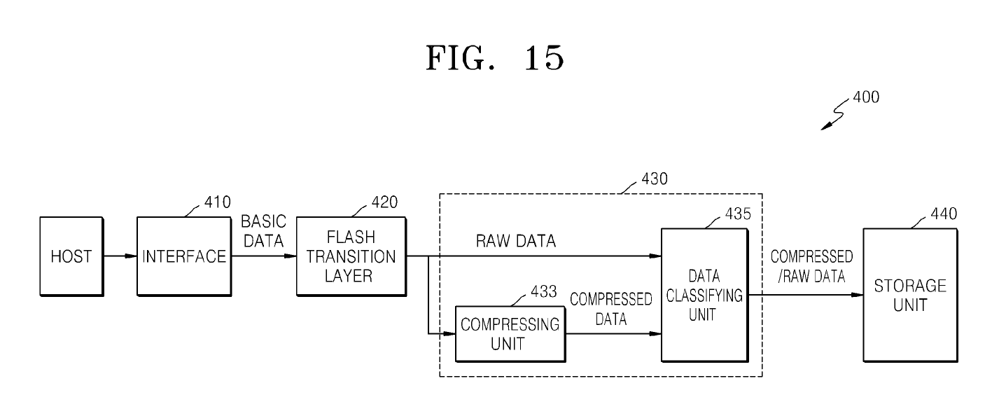

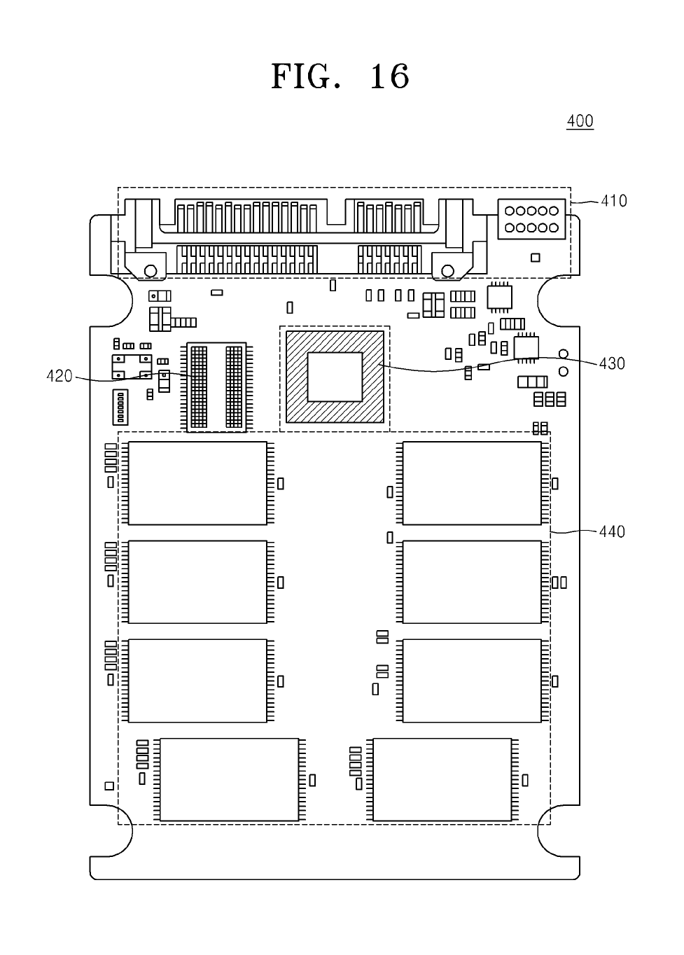

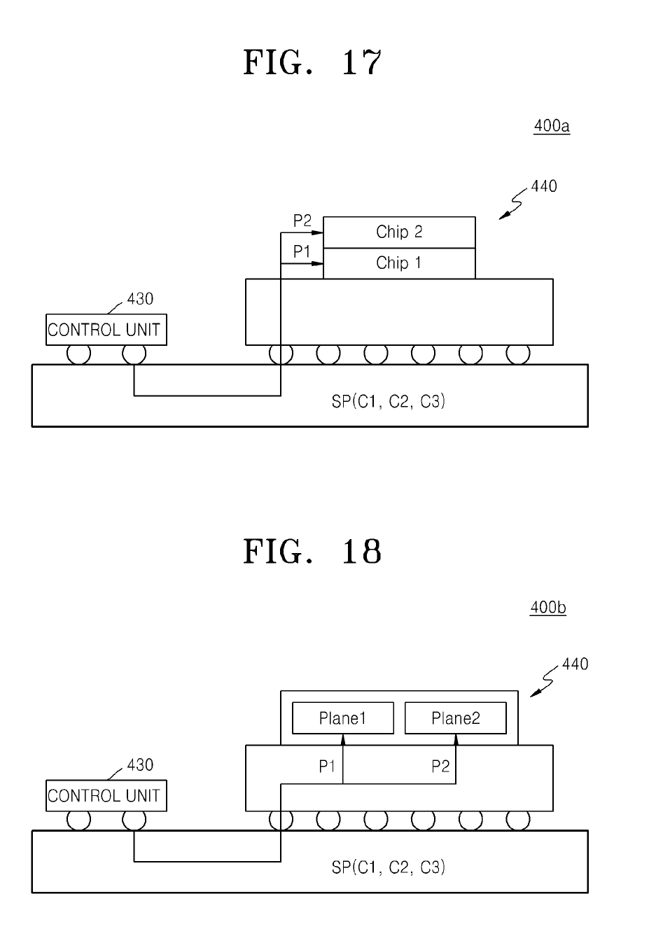

FIGS. 15 and 16 are respectively a block diagram and a plan view illustrating a storage device 400 according to an embodiment of the inventive concept.

Referring to FIGS. 15 and 16, the storage device 400 may include an interface 410, a flash transition layer (FTL) 420, a control unit 430, and a storage unit 440. While a SSD is described as the storage device 400, the inventive concept is not limited thereto. That is, the inventive concept may also be applied to storage devices such as hard disk.

Communication with a host is performed via the interface 410. That is, data to be written to the storage unit 440 is transmitted from the host or data loaded from the storage unit 440 may be transmitted to the host. The interface 410 may include a protocol for performing data exchange between the host and the storage unit 440. Examples of the protocol may include, for example, PCI-E, ATA (Advanced Technology Attachment), Serial-ATA, Parallel-ATA, SCSI, ESDI, and IDE (Integrated Drive Electronics).

The FTL 420 may receive basic data provided via the interface 410 and convert the same to raw data appropriate for a flash type. The basic data generated by using a protocol such as PCI-E, ATA, or Serial-ATA described above may not be directly stored in the storage unit 440 such as a flash memory. Accordingly, an operation of converting basic data to raw data appropriate for a flash memory needs to be performed. The FTL 420 may perform the converting operation to generate raw data from the basic data.

Although not shown in FIGS. 15 and 16, the FTL 420 may include a buffer (not shown) for temporarily storing received basic data or generated raw data. Also, the FTL 420 may be implemented inside the control unit 430.

The control unit 430 may receive raw data and store the same in the storage unit 440. The control unit 430 may include a compressing unit 433 and a data classifying unit 435. The compressing unit 433 may generate compressed data from raw data. By comparing a compression ratio of compressed data with a reference compression ratio, the data classifying unit 435 may determine whether to store compressed data or raw data corresponding to the compressed data in a super page of the storage unit 440.

The FTL 420 and the control unit 430 may be elements used in performing the data compressing method according to the embodiments of the inventive concept. For example, the generation of raw data (S110 in FIG. 1) may be performed by using the FTL 420. The generation of compression data (S120) may be performed by using the compressing unit 433 inside the control unit 430. Also, the defining of a super page (S130) and the selecting of compression data (S140) and storing of the same in the super page (S150) may be performed by using the data classifying unit 435.

As described above, in the defining of a super page, the super page may be defined to have at least two allocation sizes in terms of a size of raw data, and in the storing of compressed data, at least three units of compressed data may be stored. In this case, the at least three units of compressed data may each have a compression ratio defined by a ratio of a size of compressed data with respect to the size of the raw data, and the compression ratio may be less than the reference compression ratio which is between 0.5 and 1.

Furthermore, the reference compression ratio may be [(the allocation size of the super page/the size of the raw data)/the number of units of the raw data stored in the super page]. For example, if an allocation size of a super page is 4 KB, and a size of raw data is 2 KB, and three units of compressed data are stored in the super page, the reference compression ratio is (4/2)/3, that is, 0.66. Also, if an allocation size of a super page is 6 KB, and a size of raw data is 2 KB, and four units of compressed data are stored in the super page, the reference compression ratio is (6/2)/4, that is, 0.75.

Meanwhile, if the reference compression ratio is set, the number of units of compressed data stored in the super page may be determined. That is, the number may be represented by [(the allocation size of the super page/the size of the raw data)/the reference compression ratio]. For example, if the allocation size of the super page is 8 KB, and the size of the raw data is 2 KB, and the reference compression ratio is 0.8, the number of units of compressed data stored in the super page may be (8/2)/0.8, that is, five.

Accordingly, (i) the reference compression ratio and (ii) the number of units of compressed data stored in the super page may be selected and varies according to the types of data. While the numerical values above are given in relation to the foregoing embodiments, the scope of the inventive concept is not limited to only these values.

For example, a super page defined to have a data allocation size that is three times (3×) the size of a normal page may be assumed. When a compression ratio of compressed data is statistically between 0.6 and 0.7, a reference compression ratio of 0.75 may be set as illustrated in FIGS. 10 and 11, and three units of compressed data stored in the super page may be set.

However, the compression ratio may vary statistically for the type of raw data received from the host. For example, raw data received from the host may be converted from image data to text data to increase an individual compression ratio. In this case, a compression ratio of compressed data obtained by compressing raw data may be usually statistically in a range from 0.3 to 0.4. In this case, the reference compression ratio may be reset to 0.5, and accordingly, six units of compressed data stored in the super page may be set.

The storage unit 440 may store raw data or compressed data. If the storage device 400 is a SSD, the storage unit 440 may be a flash memory package, and in this case, various packaging methods may be used for flash memory packaging.

FIGS. 17 and 18 are plan views illustrating storage devices 400a and 400b including the control unit 430 and the storage unit 440 of FIGS. 15 and 16 according to embodiments of the inventive concept. FIGS. 17 and 18 illustrate compressed data stored in a super page, which is a logical concept, being stored in a page that is a physical concept in a memory chip.

Referring to the embodiment of FIGS. 8 and 9, the super page SP having an allocation size which is three times a size of raw data is defined, and the first through third compressed data C1, C2, and C3 may be stored in the super page SP.

In this case, referring to FIG. 17, the first through third compressed data C1, C2, and C3 stored in the super page SP may be stored in each page of a plurality of memory chips. That is, the control unit 430 may divide the compressed data C1, C2, and C3 stored in the super page SP into a first page P1 and a second page P2 and store the same in a first memory chip and a second memory chip. Accordingly, the first compressed data C1 and a portion of the second compressed data C2 may be stored in the first memory chip as the first page P1, and the rest of the second compressed data C2 and the third compressed data C3 may be stored in the second memory chip as the second page P2.

Also, referring to FIG. 18, the compressed data C1, C2, and C3 stored in the super page SP may be stored in pages of different planes in a single memory chip. That is, the control unit 430 may divide the compressed data C1, C2, and C3 stored in the super page SP separately in the first page P1 and the second page P2 and store the same in a first plane and a second plane in a single memory chip, respectively. Accordingly, the first compressed data C1 and a portion of the second compressed data C2 may be stored in the first plane as the first page P1, and the rest of the second compressed data C2 and the third compressed data C3 may be stored in the second plane as the second page P2.

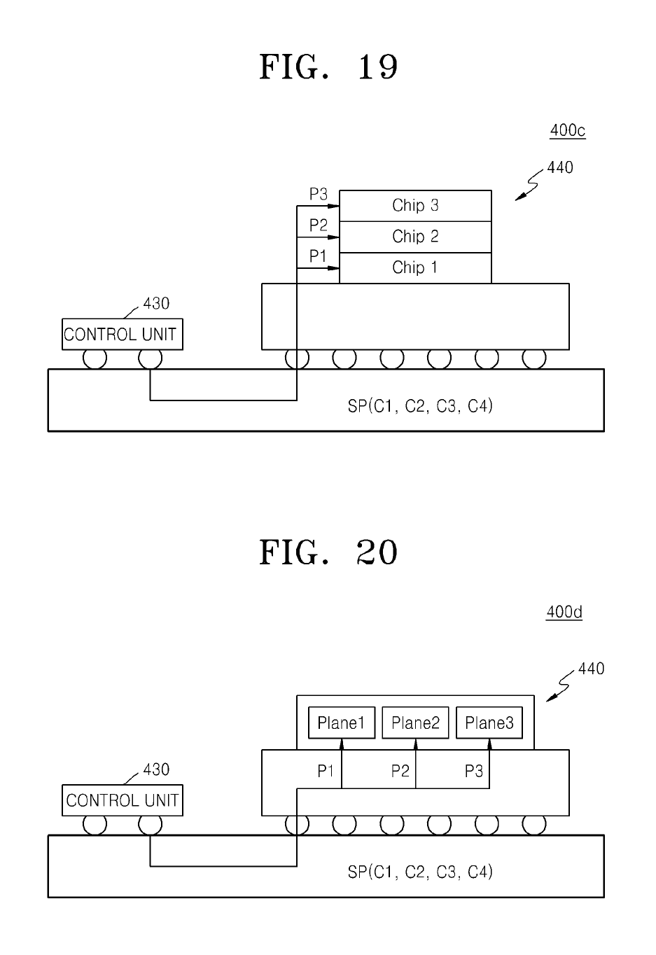

FIGS. 19 and 20 are plan views illustrating storage devices 400c and 400d including a control unit 430 and a storage unit 440 as illustrated in FIGS. 15 and 16, according to other embodiments of the inventive concept, which may be modification examples of the embodiment of FIGS. 17 and 18. Here, the description will focus on differences from the previous embodiment.

Referring to the embodiment of FIGS. 10 and 11, the super page SP having an allocation size that is three times a size of raw data is defined and the first through fourth compressed data C1, C2, C3, and C4 may be stored in the super page SP.

When the first through fourth compressed data C1, C2, C3, and C4 stored in the super page SP are stored in pages of a plurality of memory chips as illustrated in FIG. 19, the first compressed data C1 and a portion of the second compressed data C2 are stored in a first memory chip as the first page P1, the rest of the second compressed data C2 and a portion of the third compressed data C3 are stored in a second memory chip as the second page P2, and the rest of the third compressed data C3 and the fourth compressed data C4 are stored in a third memory chip as the third page P3.

When the first through fourth compressed data C1, C2, C3, and C4 stored in the super page SP are stored in pages of different planes in a single memory chip as illustrated in FIG. 20, the first compressed data C1 and a portion of the second compressed data C2 are stored in a first plane in the single memory chip as the first page P1, and the rest of the second compressed data C2 and a portion of the third compressed data C3 are stored in a second plane in the single memory chip as the second page P2, and the rest of the third compressed data C3 and the fourth compressed data C4 are stored in a third plane in the single memory chip as the third page.

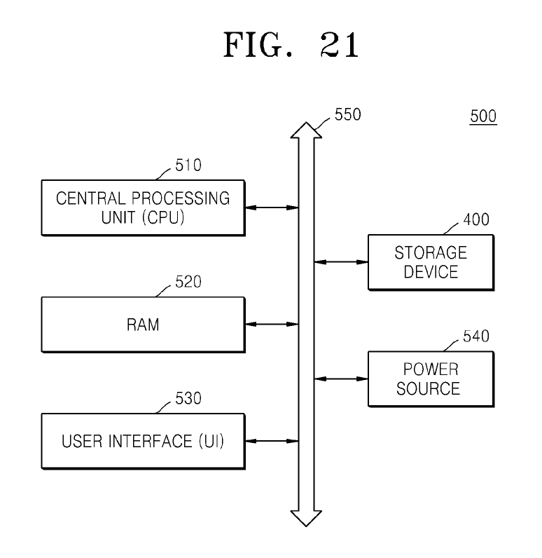

FIG. 21 is a block diagram illustrating a computing system 500 including a storage device 400 according to an embodiment of the inventive concept.

Referring to FIG. 21, the computing system 500 may include a central processing unit (CPU) 510, a random access memory (RAM) 520, a user interface (UI) 530, a power source 540, and the storage device 400.

The storage device 400 may be electrically connected to the CPU 510, the RAM 520, the UI 530, and the power source 540 via a system bus 550. Data that is provided via the UI 530 or processed using the CPU 510 may be stored in the storage device 400. The storage device 400 may be a SSD, and in this case, a booting speed of the computing system 500 may remarkably increase.

While the inventive concept has been particularly shown and described with reference to exemplary embodiments thereof, it will be understood that various changes in form and details may be made therein without departing from the scope of the following claims.

What is claimed is:

1. A data compression method, comprising:
generating compressed data from raw data, wherein the compressed data is generated with a normal size;
defining a super page for a memory, wherein the super page has a super size that is greater than the normal size;
selecting a compressed data set from among the compressed data having a compression ratio less than a reference compression ratio; and
storing the compressed data set in the memory using the super page,
wherein the compression ratio is a ratio defined in relation to the normal size and ranges between 0.5 and 1.0.

2. The method of claim 1, wherein the storing the compressed data in the memory using the super page comprises:
when first compressed data among the compressed data has a compression ratio less than the reference compression ratio, storing the first compressed data in the super page; and
when second compressed data among the compressed data has a compression ratio greater than or equal to the reference compression ratio, storing raw data corresponding to the second compressed data in the super page.

3. The method of claim 1, wherein a data allocation size for the super page is an even-numbered multiple of the normal size.

4. The method of claim 3, wherein the data allocation size for the super page is two times the normal size.

5. The method of claim 1, wherein a data allocation size for the super page is an odd-numbered multiple of the normal size.

6. The method of claim 5, wherein the data allocation size for the super page is three times the normal size.

7. The method of claim 1, wherein the reference compression ratio ranges from between 0.63 and 0.69.

8. The method of claim 1, wherein the reference compression ratio ranges from between 0.72 and 0.78.

9. The method of claim 1, wherein the memory comprises a memory chip and the compressed data stored in the super page is stored in pages at different memory array planes in the memory chip.

10. The method of claim 1, wherein the memory comprises a plurality of memory chips and the compressed data stored in the super page is stored in respective pages of the plurality of memory chips.

11. A data compression method, the method comprising:
generating a plurality of units of compressed data by compressing raw data;
defining a super page having a data allocation size that is at least two times a size of the raw data; and
storing at least three units of compressed data in the super page,
wherein the at least three units of compressed data each has a compression ratio defined by a predetermined ratio of a size of compressed data with respect to a size of raw data, and the compression ratio is less than a reference compression ratio that ranges from between 0.5 and 1.0.

12. The method of claim 11, wherein the reference compression ratio is a value determined by a relationship [(a data allocation size for the super page/a normal size for the raw data)/a number of units of the raw data that can be stored in the super page].

13. The method of claim 11, wherein the number of units of the compressed data that can be stored in the super page is a value determined by a relationship [(a data allocation size for the super page/a normal size for the raw data)/the reference compression ratio].

14. A data compression method for use in a flash memory system, the method comprising:
generating 1st through Kth units of compressed data from corresponding 1st through Kth units of raw data, wherein each unit of raw of data has a normal size;
defining a super page for the flash memory system having a data allocation size that is at least two times the normal size and storing a number of units of the compressed data; and
sequentially on a unit by unit basis for each unit of the 1st through Kth units of compressed data, determining whether the unit of compressed data has a compression ratio less than a reference compression ratio ranging between 0.5 and 1.0;
if the unit of compressed data has a compression ratio less than the reference compression ratio, classifying the unit as first type, and if the unit of compressed data has a compression ratio not less than the reference compression ratio, classifying the unit as second type; and
if the unit is classified as first type, storing the compressed data of the unit in the super page, and if the unit is classified as second type, storing the raw data corresponding to the compressed data of the unit in the super page.

15. The method of claim 14, wherein the reference compression ratio is a value determined by a relationship [(a data allocation size for the super page/the normal size)/a number of units of the raw data that can be stored in the super page].

16. The method of claim 14, wherein the number of units of the compressed data that can be stored in the super page is a value determined by a relationship [(a data allocation size for the super page/the normal size)/the reference compression ratio].

17. The method of claim 14, wherein a data allocation size for the super page is an even-numbered multiple of the normal size.

18. The method of claim 14, wherein the reference compression ratio is greater than 0.63 and less than 0.78.

19. The method of claim 14, wherein the flash memory system comprises a flash memory chip and the compressed data stored in the super page is stored in pages at different memory array planes of the flash memory chip.

20. The method of claim 14, wherein the flash memory system comprises a plurality of flash memory chips and the compressed data stored in the super page is stored in respective pages of the plurality of flash memory chips.
